(19) United States
(12) Patent Application Publication
(10) Pub. No.: US 2016/0239616 A1
(43) Pub. Date: Aug. 18, 2016

(54) MEDICAL SUPPORT SYSTEM, METHOD AND APPARATUS FOR MEDICAL CARE

(71) Applicant: FUJIFILM Corporation, Tokyo (JP)

(72) Inventors: Ryosuke USAMI, Tokyo (JP); Satoshi UEDA, Tokyo (JP); Takamasa YAGUCHI, Tokyo (JP); Yuya KUDO, Tokyo (JP); Hironori MATSUMASA, Tokyo (JP); Yasunori OHTA, Tokyo (JP)

(73) Assignee: FUJIFILM Corporation, Tokyo (JP)

(21) Appl. No.: 15/041,075

(22) Filed: Feb. 11, 2016

(30) Foreign Application Priority Data
Feb. 12, 2015 (JP) 2015-025389

(51) Int. Cl. G06F 19/00; G06F 17/30

(52) U.S. Cl. CPC G06F 19/327; G06F 19/322; G06F 17/30554

(57) ABSTRACT

A medical support system provides timeline information having medical care information of a patient arranged in a time sequence for use in medical care of the patient. A timeline entry device registers the timeline information in a database in association with fingerprint information (biometric information) for identifying the patient. A timeline readout device reads out the timeline information from the database by search upon identity verification of the fingerprint information. Furthermore, a timeline matching device operates upon acquiring plural sets of the timeline information with identity verification of the fingerprint information, and generates multi-user timeline information by matching the plural sets of the timeline information in the time sequence. Preferably, the timeline entry device is provided with the timeline information by plural medical service providers for the medical care of the patient. Information sharing of the timeline information is performed between the medical service providers.

### CROSS-REFERENCE TO RELATED APPLICATION

This application claims priority under 35 USC 119 from Japanese Patent Application No. 2015-025389, filed 12 Feb. 2015, the disclosure of which is incorporated by reference herein.

### BACKGROUND OF THE INVENTION

1. Field of the Invention

The present invention relates to a medical support system, method and apparatus for medical care. More particularly, the present invention relates to a medical support system, method and apparatus for medical care, in which plural sets of timeline information of medical care for one common patient can be viewed and utilized easily.

2. Description Related to the Prior Art

In case an injury or acute disease occurs to a person, he or she as a patient requires medical care of a doctor. An ambulance is used to transport the patient to a hospital by emergency action of paramedics. The patient is diagnosed and treated medically in the hospital in emergency medicine. The doctor in the hospital sees and checks up the patient to find symptoms of the injury, disease or disorder. Treatment of the patient is performed after deciding a plan of the treatment on the basis of the diagnosis. In the emergency medicine, doctors, nurses and other medical professionals perform intervention to the patient in a medical team in a rapid manner. There is conception of sharing medical care information between the doctors, nurses and other medical professionals for the purpose of effectively performing medical care to the patient.

U.S. Pat. Pub. No. 2009/222,286 (corresponding to JP-A 2009-518732) discloses a medical support system. A medical support server apparatus generates timeline information (workflow information) in which the medical care information, such as a diagnostic image and progress note of the patient, is arranged and managed along a timeline bar of a time sequence. The server apparatus transmits the timeline information to plural client terminal apparatuses used by the doctors, nurses and other medical professionals. In the medical support system, the medical care information of the patient is registered with the timeline information. It is possible for the doctors, nurses and other medical professionals to share the medical care information of the patient by use of the timeline information. Progress of a medical condition of the patient can be grasped readily with high visual perceptibility.

The medical care information of one patient is registered in one set of the timeline information. Plural sets of the timeline information are managed by use of case IDs which are allocated to respectively patients by the hospital where the patients are cared. Also, information of the doctors, nurses and other medical professionals is registered with the timeline information on a condition of permission of access to the timeline information.

However, the timeline information is managed by each one of medical service providers such as a hospital in the medical support system in U.S. Pat. Pub. No. 2009/222,286. There is a problem in impossibility of using the timeline information for a medical professional in one of the medical service providers after creation of the timeline information in a different one of the medical service providers, even though plural sets of the timeline information have been generated for the same patient.

Let the patient be transported to a hospital by the ambulance. The paramedics in an ambulance crew or paramedic team perform prehospital treatment to the patient in an emergency site where the ambulance has arrived. The ambulance crew constitutes one of the medical service providers for medical care of the patient. In case the patient is transported to a first hospital facility by the ambulance crew, the patient is cared in the first hospital facility as a succeeding one of the medical service providers. Furthermore, in case the patient is transferred to a second hospital facility different from the first hospital facility, the patient is cared in the second hospital facility as another one of the medical service providers. The timeline information can be created by each one of the ambulance crew, the first hospital facility and the second hospital facility. Thus, three sets of the timeline information become created for the same patient as a result of medical care in the three medical service providers.

In the medical care for the patient, information of the past medical care for him or her is very important. For example, medical care information of the ambulance crew is important in the first hospital facility. Medical care information of the ambulance crew and the first hospital facility is important in the second hospital facility.

In the medical support system of U.S. Pat. Pub. No. 2009/222,286, the timeline information is produced in each one of the medical service providers. Assuming that there is agreement between the first and second hospital facilities, the timeline information may be exchanged between the medical support systems of the first and second hospital facilities by use of network connection or the like. However, the timeline information is managed by use of the ID information allocated by each one of the medical service providers exclusively. It is impossible in a second one of the medical service providers to specify the timeline information provided from a first one of the medical service providers, because the case ID of a patient of the first medical service provider cannot be used in the second medical service provider. The use of the timeline information is very difficult, as specific information of the patient, such as a name, age, sex and address, must be used for identification for the purpose of utilizing the timeline information of the other medical service provider.

### SUMMARY OF THE INVENTION

In view of the foregoing problems, an object of the present invention is to provide a medical support system, method and apparatus for medical care, in which plural sets of timeline information of medical care for one common patient can be viewed and utilized easily.

In order to achieve the above and other objects and advantages of this invention, a medical support system for providing timeline information having medical care information of a patient arranged in a time sequence for use in medical care of the patient is provided. A timeline entry device registers the timeline information in a storage medium in association with biometric information for identifying the patient. A timeline readout device reads out the timeline information from the storage medium by search upon identity verification of the biometric information. There is an information distributor for information distribution of the timeline information being read out.

Preferably, furthermore, a timeline matching device operates upon acquiring plural sets of the timeline information with identity verification of the biometric information, and generates multi-user timeline information by matching the plural sets of the timeline information in the time sequence.

Preferably, the timeline entry device registers associated information in association with the timeline information, and the associated information is used for determining permission of access to the timeline information.

Preferably, the associated information includes at least one of user information of a user permitted to perform access to the timeline information, and area information of an area in which information distribution of the timeline information is possible.

Preferably, furthermore, a specifying device operates upon receiving a request from a requester among plural users, and selectively specifies the timeline information to which the requester is permitted to perform access according to the associated information, to transmit the timeline information to the requester.

Preferably, location information of the requester is acquired by a GPS locator, and transmitted from the requester together with the request. The specifying device specifies the timeline information of accessibility by use of the location information and the area information.

Preferably, the timeline entry device is provided with the timeline information by each of plural medical service providers for the medical care of the patient. The information distributor performs information sharing of the timeline information between the medical service providers.

Preferably, the medical service providers include an ambulance crew and at least one hospital facility. Preferably, there are plural server apparatuses each of which includes the timeline entry device, the timeline readout device and the timeline matching device.

Preferably, the plural server apparatuses include a first server apparatus for outputting a request for reading out the timeline information. A second server apparatus reads out the timeline information by referring to the biometric information in response to outputting the request for readout, for transmitting the timeline information to the first server apparatus by use of the information distributor.

Preferably, the biometric information is fingerprint information.

Preferably, the timeline entry device receives an entry request for newly entering the timeline information in association with the biometric information, and newly generates the timeline information upon receiving the entry request.

Preferably, furthermore, a local server apparatus outputs a request for reading out the timeline information. A medical support server apparatus includes the timeline entry device, the timeline readout device and the timeline matching device, reads out the timeline information by referring to the biometric information in response to outputting the request for readout, and transmits the timeline information to the first server apparatus by use of the information distributor.

Also, a medical support method for providing timeline information having medical care information of a patient arranged in a time sequence for use in medical care of the patient is provided. An entry request for newly entering the timeline information in association with biometric information for identifying the patient is received. The timeline information is newly generated upon receiving the entry request. The timeline information is registered in a storage medium in association with the biometric information. The timeline information from the storage medium is read out by search upon identity verification of the biometric information. Information distribution of the timeline information being read out is performed.

Also, a medical support apparatus for providing timeline information having medical care information of a patient arranged in a time sequence for use in medical care of the patient is provided. A request processing unit receives an entry request for newly entering the timeline information in association with biometric information for identifying the patient. A timeline generator newly generates the timeline information upon receiving the entry request. A timeline entry device registers the timeline information in a storage medium in association with the biometric information. A timeline readout device reads out the timeline information from the storage medium by search upon identity verification of the biometric information. There is an information distributor for information distribution of the timeline information being read out.

Consequently, plural sets of timeline information of medical care for one common patient can be viewed and utilized easily, because biometric information can be utilized to read out and specify timeline information suitably.

### BRIEF DESCRIPTION OF THE DRAWINGS

The above objects and advantages of the present invention will become more apparent from the following detailed description when read in connection with the accompanying drawings, in which: FIG. 1 is a block diagram schematically illustrating an emergency medicine system;

FIG. 2 is a block diagram schematically illustrating a medical support system;

FIG. 3 is a block diagram schematically illustrating arrangement of circuit devices in a medical support server apparatus;

FIG. 4 is a block diagram schematically illustrating circuit device in a portable terminal device and a hospital terminal apparatus;

FIG. 5 is a data chart illustrating various sets of timeline information;

FIGS. 6A, 6B and 6C are block diagrams schematically illustrating respectively server apparatuses;

FIG. 7 is a data chart illustrating generation of multi-user timeline information;

FIG. 8 is a block diagram schematically illustrating the medical support server apparatus;

FIG. 9 is a flow chart illustrating a flow of using timeline information;

FIG. 10 is a flow chart illustrating information distribution of timeline information from a hospital server apparatus and medical support server apparatus;

FIG. 11 is a block diagram schematically illustrating another preferred medical support server apparatus having a specifying device;

FIG. 12 is a data chart illustrating information distribution of timeline information only of access permission;

FIG. 13 is a block diagram schematically illustrating use of GPS location information;

FIG. 14 is a data chart illustrating a system timeline database combined with the server apparatus;

FIG. 15 is a block diagram schematically illustrating use of each one of server apparatuses for a medical support server apparatus;

FIG. 16 is a block diagram schematically illustrating information distribution of timeline information from one server apparatus to another server apparatus as requester.

### DETAILED DESCRIPTION OF THE PREFERRED EMBODIMENT(S) OF THE PRESENT INVENTION

### First Embodiment

In FIG. 1, an emergency medicine system is illustrated.

Assuming that an acute disease or serious injury occurs to a body of a person, an ambulance with paramedics is called urgently for transporting the person to a hospital as a medical service provider, so that a doctor can perform medical care to the person in the emergency medicine. The emergency medicine system includes a medical center 11 of a local community, an emergency response organization 12 (emergency command center or central headquarter), a first hospital facility 13, a second hospital facility 14 and the like. Although each of the emergency response organization 12, and the first and second hospital facilities 13 and 14 is one entity in FIG. 1 for simplicity in the drawing, it is possible that each of the emergency response organization 12, and the first and second hospital facilities 13 and 14 is two or more. The medical center 11 is a comprehensive medical facility, such as a medical center for liaison with plural medical service providers in a particular local area.

The emergency response organization 12 receives an urgent call from the patient P, his or her family, passer-by or the like in an emergency site 15, and locally specifies the emergency site by recognizing information according to the call. The emergency response organization 12 instructs an emergency service agency (fire station or the like) near to the emergency site 15 to dispatch an ambulance 16 to the patient P. An ambulance crew 17 or paramedic team inclusive of plural paramedics F (emergency medical technicians) is organized by the emergency service agency, and dispatches the ambulance 16. The ambulance crew 17 arrives at the emergency site 15, treats the patient P for prehospital treatment, and picks him or her in the ambulance 16. The emergency response organization 12 and the ambulance crew 17 in combination are a medical service provider for prehospital treatment to the patient P. The ambulance crew 17 calls the first hospital facility 13 and asks for medical care of the patient P. In case the first hospital facility 13 approves the care of the patient P, the ambulance crew 17 transports him or her to the first hospital facility 13.

The first hospital facility 13 is an emergency hospital having medical instruments and systems for emergency medicine, to perform medical care of a patient P (patient body). A doctor D1 at the first hospital facility 13 cares the patient P transported by paramedics. The second hospital facility 14 is a specialized hospital for specialized and advanced medical care for serious patients for which the first hospital facility 13 cannot perform medical care sufficiently. A doctor D2 at the second hospital facility 14 cares the patient P transferred from the first hospital facility 13.

Each one of the ambulance crew 17, and the first and second hospital facilities 13 and 14 as medical service providers creates timeline information (workflow information), in which medical care information related to diagnosis and treatment for the patient P is arranged and recorded in a time sequence. The medical care information in the timeline information includes information of medical care in the past and also information of planned medical care in the future.

Emergency timeline information TL0 is related to medical care information of medical care performed by the ambulance crew 17. First hospital timeline information TL1 is related to medical care information of medical care performed in the first hospital facility 13. Second hospital timeline information TL2 is related to medical care information of medical care performed in the second hospital facility 14.

A medical support system 10 is a system for sharing plural sets of timeline information between plural medical service providers for the same patient P, for example, emergency timeline information TL0, first hospital timeline information TL1 and second hospital timeline information TL2. The medical support system 10 makes it possible easily to provide timeline information from other medical service providers in relation to the same patient P.

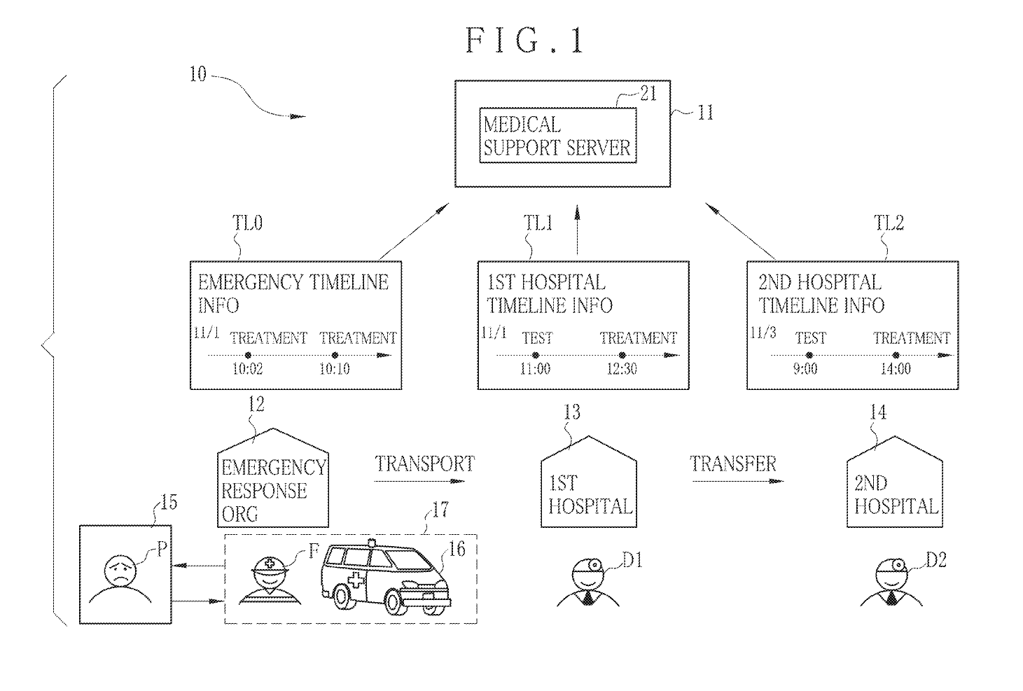

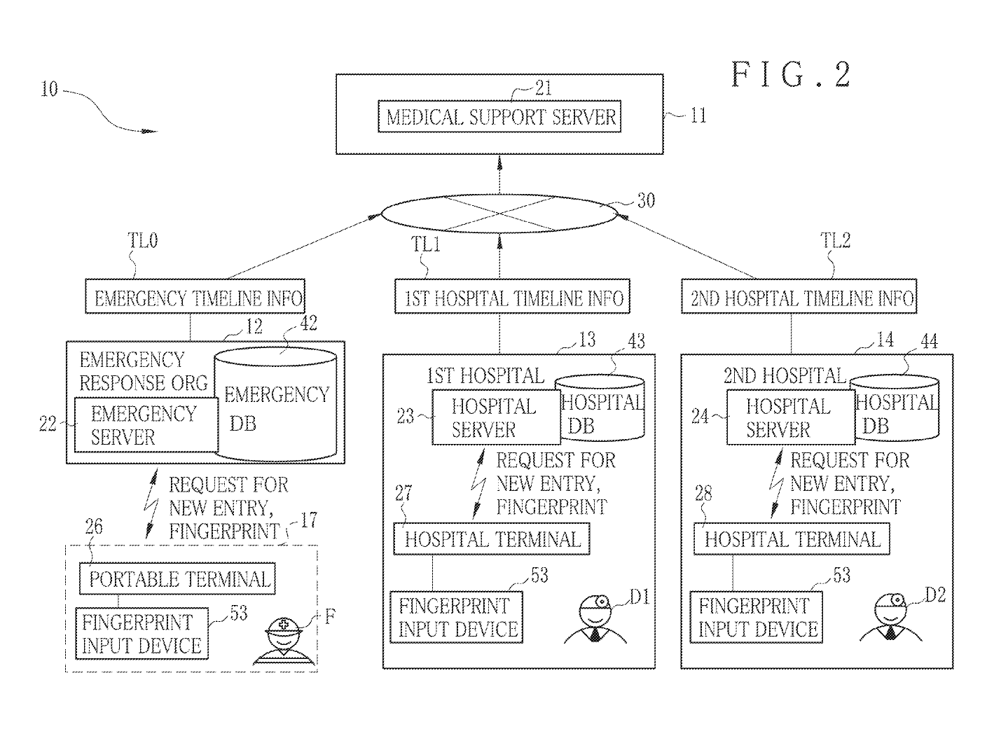

In FIG. 2, the medical support system 10 includes a medical support server apparatus 21, an emergency server apparatus 22 and hospital server apparatuses 23 and 24. The medical support server apparatus 21 is installed in the medical center 11. The emergency server apparatus 22 (local server apparatus) is installed in the emergency response organization 12. The hospital server apparatuses 23 and 24 (local server apparatuses) are respectively installed in the first and second hospital facilities 13 and 14. The emergency server apparatus 22 produces emergency timeline information TL0. The hospital server apparatus 23 produces first hospital timeline information TL1. The hospital server apparatus 24 produces second hospital timeline information TL2.

The emergency server apparatus 22 is combined with an emergency database 42 or DB. The hospital server apparatus 23 is combined with a hospital database 43 or DB. The hospital server apparatus 24 is combined with a hospital database 44 or DB. In the plural server apparatuses 22, 23 and 24, generated timeline information TL0, TL1 and TL2 is stored in respectively the plural databases 42, 43 and 44 as storage medium.

The medical support server apparatus 21 acquires the timeline information TL0, TL1 and TL2 from the emergency server apparatus 22 and the hospital server apparatuses 23 and 24, and distributes the timeline information TL0, TL1 and TL2 to medical service providers other than sources of the information. For example, the medical support server apparatus 21 transmits the emergency timeline information TL0 to the first hospital facility 13 after generation in the emergency server apparatus 22 according to a request from the first hospital facility 13.

A communication network 30 connects the emergency server apparatus 22, and the hospital server apparatuses 23 and 24 to the medical support system 10. Examples of the communication network 30 are the Internet, mobile communication network and the like.

At least one portable terminal device 26 becomes connected to the emergency server apparatus 22 communicably for use by a paramedic F. Also, hospital terminal apparatuses 27 and 28 or local terminals become connected to the hospital server apparatuses 23 and 24 communicably for use by medical professionals, such as the doctors D1 and D2 at the first and second hospital facilities 13 and 14. The plural server apparatuses 22, 23 and 24 generate timeline information TL0, TL1 and TL2 according to requests from the plural terminal apparatuses 26, 27 and 28 in relation to newly entering the timeline information.

The portable terminal device 26 is used by each of plural paramedics F in the ambulance crew 17, for example, a smart phone, tablet computer and the like. The portable terminal device 26 transmits a request for newly entering emergency timeline information TL0 to the emergency server apparatus 22 of the emergency response organization 12 by use of the communication network 30. The portable terminal device 26 transmits a request to the emergency server apparatus 22 for registering medical care information of the patient P collected in the emergency site 15 by the paramedic F. The emergency server apparatus 22 registers the medical care information from the portable terminal device 26 with the emergency timeline information TL0 in a sequence of reception according to the request for registration.

The medical care information includes vital information, message information (comment), images and the like. The vital information includes a blood pressure, respiratory rate, body temperature, electrocardiogram and the like of the patient P. The message information is text of description of the emergency site 15 or the patient P and input by the paramedic F. The images are still images or moving images of the body of the patient P or the emergency site 15. Also, the message information includes triage information related to emergency of medical care by consideration of the paramedic F for the patient P. To acquire the medical care information, it is possible to utilize an imaging function of a camera in the portable terminal device 26. Also, description can be input by voice assuming that the portable terminal device 26 has a microphone and audio recorder for inputting the voice. It is possible to record voice of other persons, for example, the patient P, witnesses and the like in the emergency site 15 as an interview relevant to the emergency medicine.

The portable terminal device 26 can perform access to the emergency server apparatus 22 to receive information distribution of the emergency timeline information TL0 for the purpose of viewing the registered emergency timeline information TL0. To this end, the portable terminal device 26 transmits a request to the emergency server apparatus 22 for the information distribution of the emergency timeline information TL0.

In the same manner as the portable terminal device 26, the hospital server apparatuses 23 and 24 of medical service providers having the hospital terminal apparatuses 27 and 28 receive transmission of a request for newly generating first and second hospital timeline information TL1 and TL2 or a request for registering medical care information. Doctors D1 and D2 transmit requests to the hospital server apparatuses 23 and 24 by use of the hospital terminal apparatuses 27 and 28, the requests including a request for registering the medical care information of a result of a diagnostic test for the patient P or a result of a diagnostic test such as images upon occurrence of the diagnostic test. The hospital server apparatuses 23 and 24 register (add) the received medical care information according to the request for registration with the first or second hospital timeline information TL1 or TL2.

The hospital terminal apparatuses 27 and 28 are communicable to perform access to the hospital server apparatuses 23 and 24 and send a request for information distribution of the timeline information TL0, TL1 and TL2 in order to view the first hospital timeline information TL1 and second hospital timeline information TL2.

The medical support server apparatus 21 performs medical support by a function (service) for sharing the timeline information between plural medical service providers. Each of the plural terminal apparatuses 26, 27 and 28 or users is allowed by the medical support server apparatus 21 to view timeline information of medical service providers other than those associated with the plural terminal apparatuses 26, 27 and 28.

For example, the hospital terminal apparatus 27 at the first hospital facility 13 utilizes the medical support server apparatus 21, and can view the first hospital timeline information TL1 registered in the hospital server apparatus 23, and also the emergency timeline information TL0 and second hospital timeline information TL2 registered in the emergency server apparatus 22 at the emergency response organization 12 and in the hospital server apparatus 24 at the second hospital facility 14. Also, the portable terminal device 26 can view the first hospital timeline information TL1 and second hospital timeline information TL2 in addition to the emergency timeline information TL0. The hospital terminal apparatus 28 can view the emergency timeline information TL0 and first hospital timeline information TL1 in addition to the second hospital timeline information TL2.

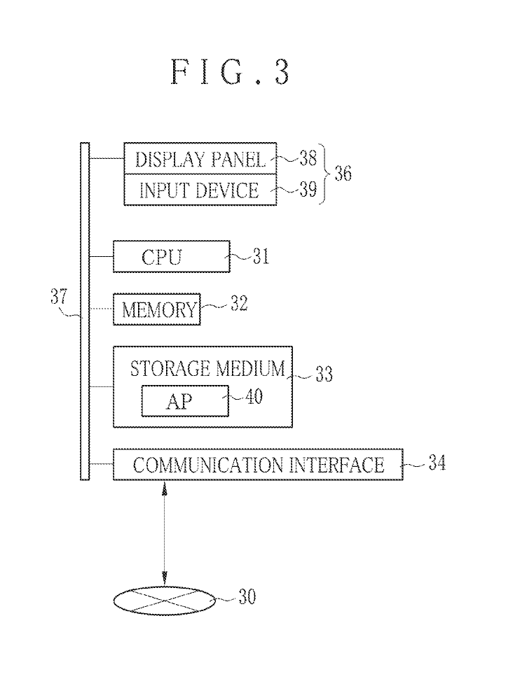

In FIG. 3, each one of the medical support server apparatus 21, the server apparatuses 22, 23 and 24, the portable terminal device 26, and the hospital terminal apparatuses 27 and 28 is constituted by a computer basically in an equal structure. The computer includes a CPU 31 (central processing unit), a non-transitory memory 32, a non-transitory storage medium 33 or storage device, a communication interface 34 and a user interface 36 for inputs and outputs. A data bus 37 interconnects those circuit devices. An example of the user interface 36 includes a display panel 38 and an input device 39, such as a keyboard and a mouse. Also, the terminal apparatus can be a portable terminal apparatus, for example, a smart phone, tablet computer and the like. The user interface 36 can be a touchscreen display panel including a display panel and a touchscreen device.

An example of the storage medium 33 is a hard disk drive (HDD). An application program 40 or AP and a control program are stored in the storage medium 33. Also, a disk array having plural HDDs is combined with a server apparatus for database by way of the storage medium 33, which is discrete from the HDD for storing the programs. Note that the disk array can be incorporated in the server apparatus, but may be an external unit separate from the server apparatus and connected to the same by use of a cable, network or the like.

The memory 32 is a working memory for the CPU 31 to perform tasks, and constituted by a RAM (random access memory). The CPU 31 loads the memory 32 with a control program stored in the storage medium 33, and controls various circuit devices in the computer by performing the tasks according to the control program. The communication interface 34 (information distributor) is a network interface for control and communication with the communication network 30.

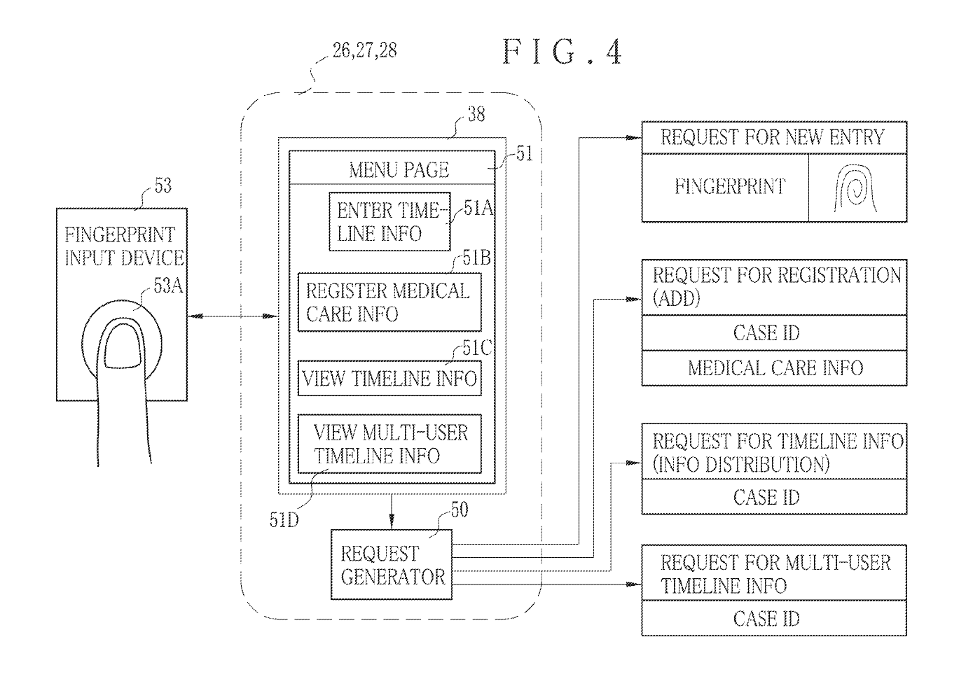

In FIG. 4, a client program for medical support is installed as the application program 40 in the storage medium 33 of each of the plural terminal apparatuses 26, 27 and 28. A request generator 50 is established in the CPU 31 by running the client program in the plural terminal apparatuses 26, 27 and 28, and generates a request for newly entering timeline information, a request for registering medical care information, and a request for information distribution of the timeline information.

A menu page 51 is displayed on the display panel 38 upon running the client program in the CPU 31. The menu page 51 includes an enter button 51A, a register button 51B, a specific timeline button 51C or normal timeline button, and a multi-user timeline button 51D or multi-user workflow button (combined timeline button) by way of a timeline matching device. The enter button 51A is operable for creating timeline information (TL) of a time sequence. The register button 51B is used for registering medical care information. The specific timeline button 51C is used for viewing specific timeline information. The multi-user timeline button 51D is used for viewing multi-user timeline information (combined timeline information).

An entry page (not shown) is displayed on the display panel 38 upon manipulation of the enter button 51A for inputting a request for new entry. In the entry page, message information is displayed for encouraging a patient P to input fingerprint information. A fingerprint input device 53 is connectable to the plural terminal apparatuses 26, 27 and 28 wirelessly or in a wired manner. The fingerprint input device 53 is constructed in the same manner as a well-known fingerprint sensor for use in a fingerprint authorization system. A reader 53A in the fingerprint input device 53 reads a fingerprint of the patient's finger, so that the fingerprint input device 53 sends fingerprint information or image data of the fingerprint to the plural terminal apparatuses 26, 27 and 28. The fingerprint information is biometric information for identifying the patient P.

In the entry page, an input action is performed to request new entry. The request generator 50 generates the request for the new entry of timeline information with attachment of fingerprint information. The request for the new entry is transmitted to the plural server apparatuses 22, 23 and 24. In the portable terminal device 26, the request is transmitted to the emergency server apparatus 22. In the hospital terminal apparatus 27, the request is transmitted to the hospital server apparatus 23.

The timeline information, being generated in the plural server apparatuses 22, 23 and 24, is registered in the plural databases 42, 43 and 44 in a tagged form with the fingerprint information. For the new entry of the timeline information, a case ID is generated by the plural server apparatuses 22, 23 and 24, and registered with the fingerprint information in a tagged form for the generated timeline information.

To register (add) the medical care information with the timeline information, the register button 51B in the menu page 51 is manipulated. A patient list (not shown) is displayed by use of the register button 51B, inclusive of the registered timeline information. The patient list includes names of patients and their case IDs. A selected one of the patients is designated manually in the patient list. In case transmission is instructed by selecting the registered medical care information, the request generator 50 generates a request for registration together with the case ID of the selected patient P and the selected medical care information. The request is transmitted to the plural server apparatuses 22, 23 and 24. The plural server apparatuses 22, 23 and 24 register the medical care information with the timeline information of the designated case ID.

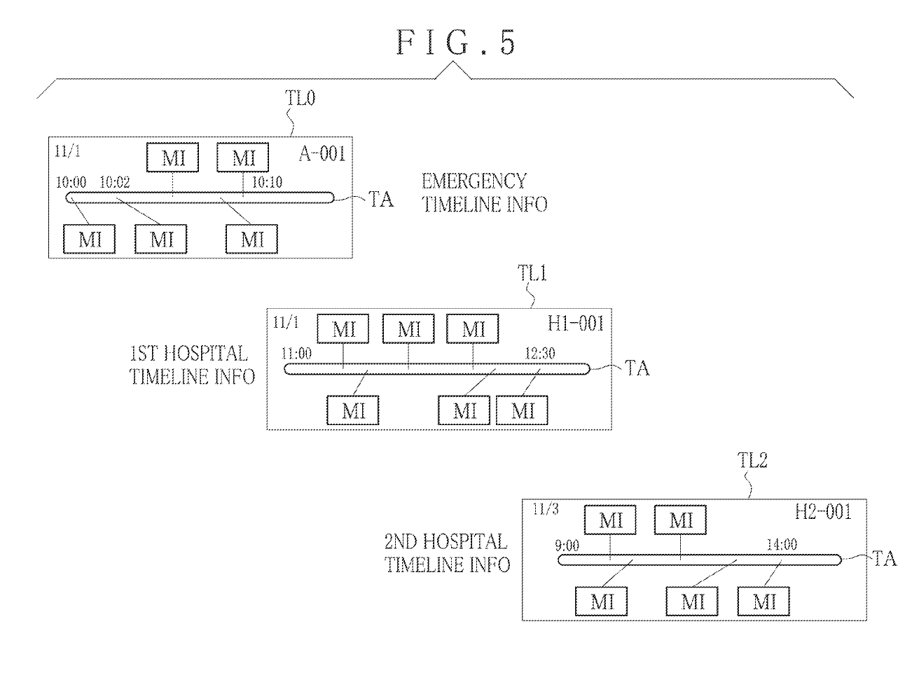

In FIG. 5, examples of the timeline information TL0, TL1 and TL2 are illustrated. A reference sign TA denotes a timeline bar of a time sequence. A reference sign MI denotes medical care information. The medical care information MI is recorded serially along the timeline bar TA of the time sequence. Examples of case IDs from medical service providers in the timeline information TL0, TL1 and TL2 are A-001, H1-001 and H2-001. In the medical service providers (users), the timeline information TL0, TL1 and TL2 is managed by use of the case IDs.

In the menu page 51 of FIG. 4, the specific timeline button 51C is a button for viewing the timeline information in the medical service providers from the plural terminal apparatuses 26, 27 and 28. A patient list (not shown) is displayed in the menu page 51 with the registered timeline information. The patient list contains names and case IDs of patients. A patient P of interest is designated among the patients in the patient list. In case the request for the information distribution is instructed, the request generator 50 generates a normal request for the information distribution together with the case ID of the designated patient P.

The plural server apparatuses 22, 23 and 24, upon receiving the normal request for the information distribution, search the timeline information of the designated case ID, and transmit this to the requester. Thus, the timeline information can be shared and viewed by the plural terminal apparatuses 26, 27 and 28.

The multi-user timeline button 51D is used for viewing multi-user timeline information in which timeline information registered for other medical service providers is added to the specific timeline information of the first medical service provider in relation to the same patient P (patient body). Press of the multi-user timeline button 51D causes a patient list to appear in the same manner as the specific timeline button 51C to designate a case ID in the patient list. Upon transmission of a request for information distribution of the multi-user timeline information, the request generator 50 generates a request for the information distribution of the multi-user timeline information with the case ID of the designated patient P.

The request for the information distribution of the multi-user timeline information is transmitted to the plural server apparatuses 22, 23 and 24. In response to this, the plural server apparatuses 22, 23 and 24 utilize the medical support server apparatus 21 and acquire timeline information created by other medical service providers in relation to the designated patient P in the request. To this end, fingerprint information registered with the timeline information is used. Each of the plural server apparatuses 22, 23 and 24 generates multi-user timeline information by combining the timeline information created by other medical service providers and the first timeline information generated in the server apparatus 22, 23 or 24. The multi-user timeline information is transmitted to the requester or terminal apparatus of the request for the information distribution. It is possible to view the timeline information in the plural terminal apparatuses 26, 27 and 28.

The application program 40 is a server program installed in the emergency server apparatus 22 and the hospital server apparatuses 23 and 24 for generating and managing timeline information. The server program is a subsidiary program or component included in the medical support computer-executable program.

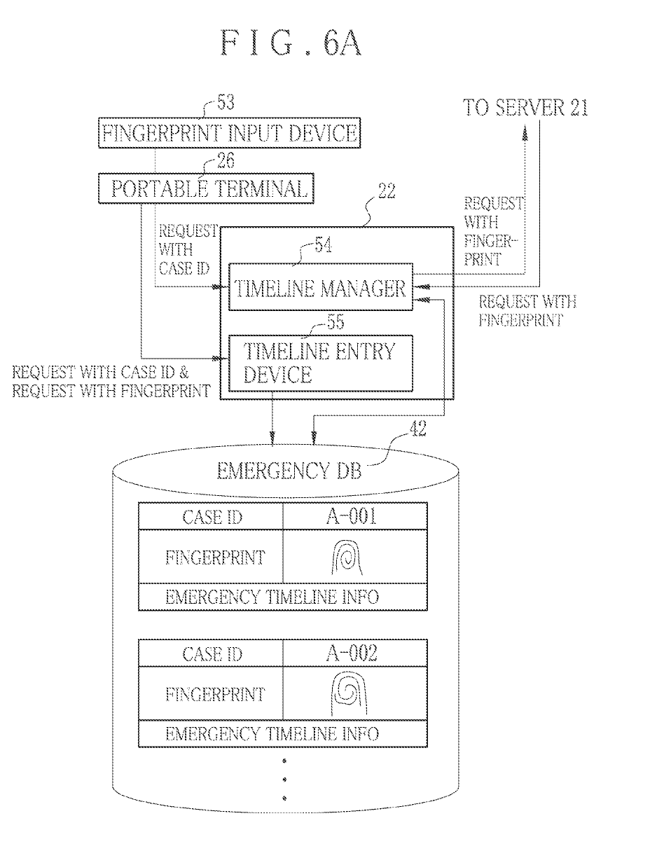

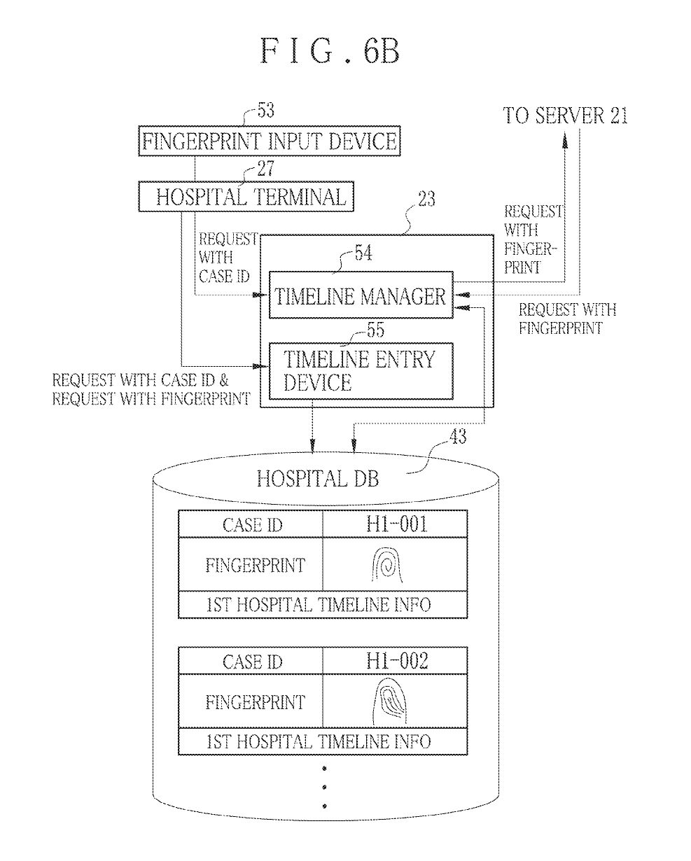

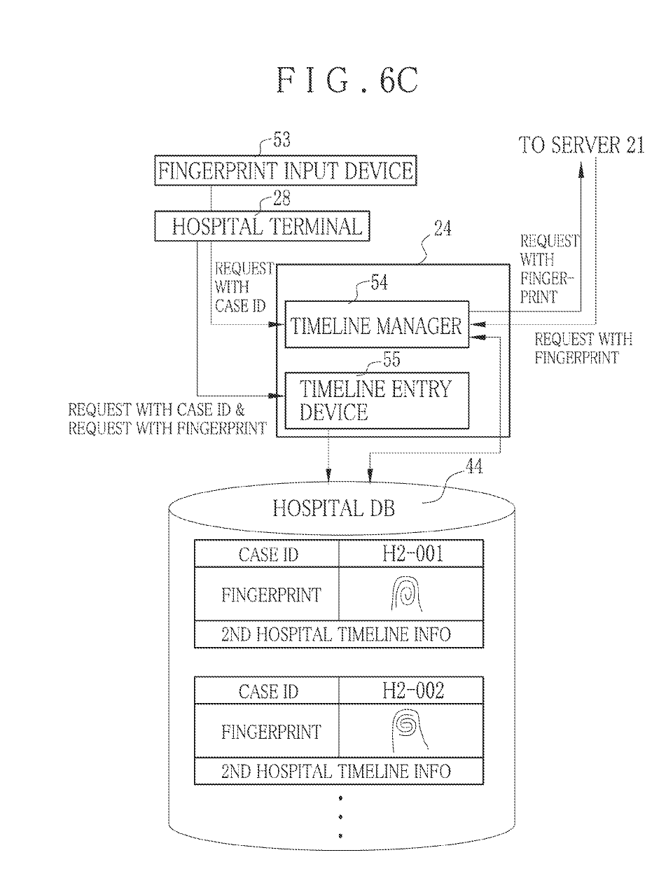

In FIGS. 6A, 6B and 6C for the plural server apparatuses 22, 23 and 24, a timeline manager 54 or workflow manager, and a timeline entry device 55 or workflow entry device (timeline registration unit) are established in the CPU 31 by running the server program in cooperation with the memory 32. The timeline entry device 55 is a request processing unit for receiving the request for new entry from the plural terminal apparatuses 26, 27 and 28. Also, the timeline entry device 55 is a timeline generator, which newly generates the timeline information of the patient P upon receiving the request from the plural terminal apparatuses 26, 27 and 28, and stores the timeline information in the plural databases 42, 43 and 44.

At the same time, the timeline information and fingerprint information of the patient P combined with the request for new entry are registered in a tagged form with one another. Also, the timeline entry device 55 generates a case ID for use in medical service providers upon newly generating the timeline information, and registers the case ID, fingerprint information and timeline information in a tagged form. The timeline entry device 55 receives a request for registering medical care information, and registers (adds) the medical care information with the timeline information. Thus, the plural databases 42, 43 and 44 are caused to store timeline information of plural patients for the respective medical service providers.

The timeline manager 54 receives the request for information distribution from the plural terminal apparatuses 26, and 28, and transmits the timeline information of the designated case ID to the requester or the terminal apparatus 26, 27 or 28. Assuming that the request for the information distribution is normal, one of plural sets of the timeline information with verification of the case ID is searched from the plural databases 42, 43 and 44, to transmit the searched set of the timeline information.

For the request for the information distribution of the multi-user timeline information, the timeline manager 54 acquires fingerprint information corresponding to the designated case ID from the plural databases 42, 43 and 44. The timeline manager 54 generates the request for the information distribution with attachment of the acquired fingerprint information, and transmits the request for the information distribution to the medical support server apparatus 21 in relation to the timeline information with identity verification of the fingerprint information among the plural sets of the timeline information created by the other medical service providers. Assuming that timeline information of another medical service provider with identity verification of the fingerprint information is searched and read out in the medical support server apparatus 21, the timeline manager 54 acquires the timeline information as a search result.

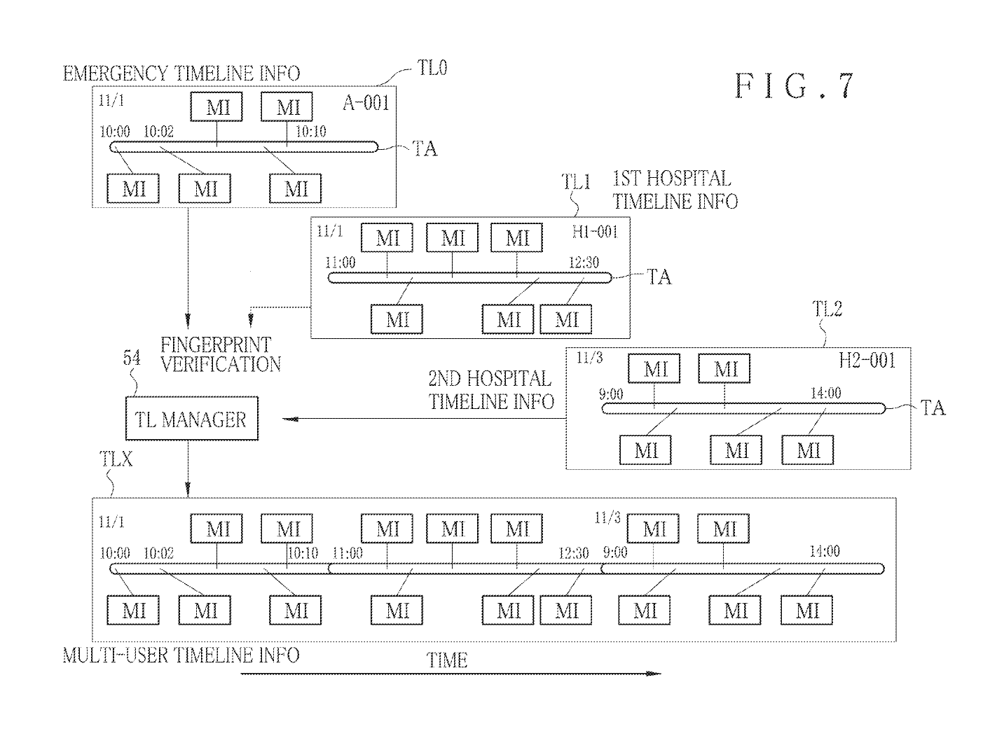

In FIG. 7, the timeline manager 54 generates multi-user timeline information TLX (combined timeline information) by combining timeline information of other medical service providers (users) with timeline information of the first medical service provider. For matching operation or combining operation of the timeline information, elements of plural workflows are arranged in a time sequence. Time information is acquired from calendar date information recorded in the timeline information. A sequence of the matching operation is determined according to the calendar date information. In case plural sets of the timeline information with the equal fingerprint information (biometric information) are read out by the search, the timeline manager 54 operates as a timeline matching device for generating the multi-user timeline information by use of the plural sets of the timeline information.

The timeline manager 54 upon receiving the request for search (readout) from the medical support server apparatus 21 searches timeline information from the plural databases 42, 43 and 44 of the medical service providers with identity verification of the fingerprint information included in the request for the search. The timeline manager 54 transmits a search result to the medical support server apparatus 21.

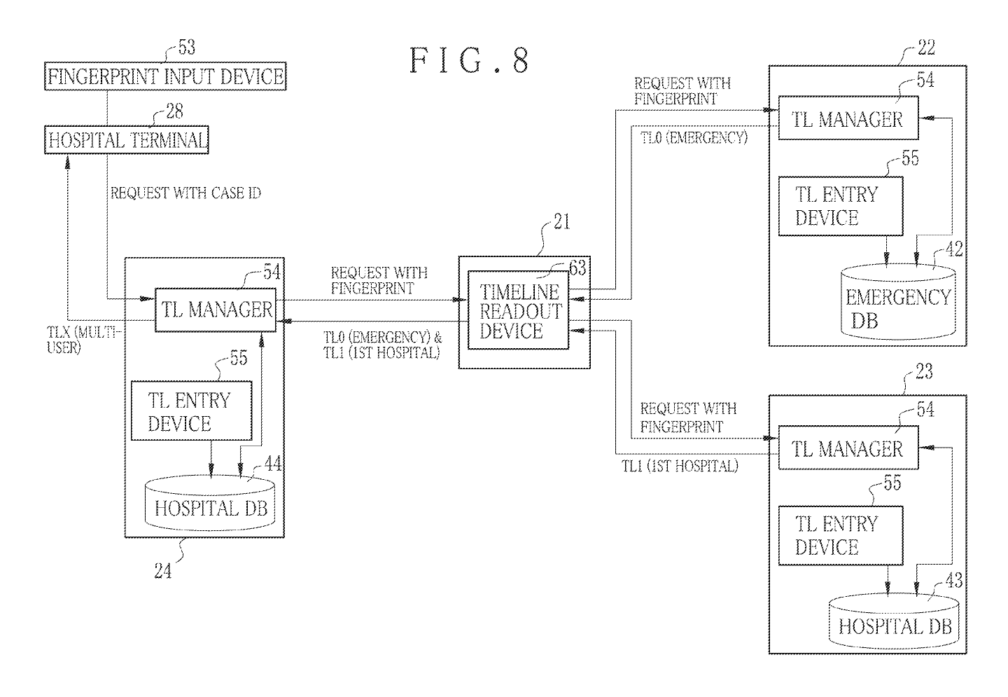

A server program as the application program 40 is installed in the medical support server apparatus 21 for searching timeline information created by plural medical service providers. The server program is a main program component included in the medical support program, which is constituted by the server program and subsidiary programs for the plural server apparatuses 22, 23 and 24. In FIG. 8, a timeline readout device 63 or workflow readout device (timeline searcher) is established in the CPU 31 in the medical support server apparatus 21 with the memory 32 by running the server program in the medical support server apparatus 21. Also, the timeline readout device 63 operates as a transmission controller (information distributor) for controlling the information distribution of the searched timeline information.

In FIG. 8, the multi-user timeline information TLX is distributed in response to the request of the information distribution of the multi-user timeline information TLX from the hospital terminal apparatus 28 at the second hospital facility 14. The timeline readout device 63 of the medical support server apparatus 21 searches the timeline information created by the plural medical service providers. In response to the request for the information distribution from the hospital server apparatus 24 at the second hospital facility 14, the timeline information

TL0 and TL1 is searched from the emergency server apparatus 22 at the emergency response organization 12 and the hospital server apparatus 23 at the first hospital facility 13 as medical service providers other than the second hospital facility 14 as a requester of the request. The timeline readout device 63 transmits the request for the search to the emergency server apparatus 22 and the hospital server apparatus 23 with attachment of the fingerprint information.

The emergency server apparatus 22 and the hospital server apparatus 23 search timeline information TL0 and TL1 from the emergency database 42 and the hospital database 43 with identity verification of the fingerprint information. The searched timeline information TL0 and TL1 is transmitted to the medical support server apparatus 21 as search results. The timeline readout device 63 distributes the timeline information TL0 and TL1 or the search results to the hospital server apparatus 24 of the requester. In the hospital server apparatus 24, the timeline manager 54 generates multi-user timeline information TLX according to the timeline information TL0 and TL2 of other medical service providers (users) from the medical support server apparatus 21, and transmits this to the hospital terminal apparatus 28.

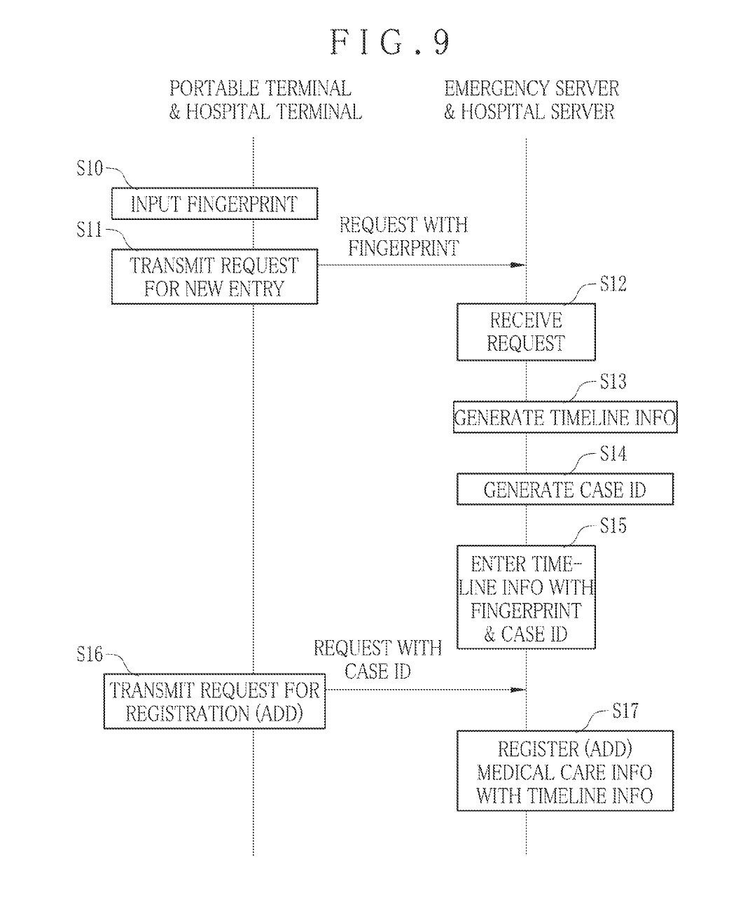

The operation of the embodiment is described now. In FIG. 9, the emergency response organization 12 is called for urgent action of emergency medicine. The ambulance crew 17 inclusive of paramedics F moves rapidly to the emergency site 15. One of the paramedics F at the emergency site 15 registers timeline information by use of the portable terminal device 26 for the purpose of inputting medical care information of a patient P. To this end, the menu page 51 in FIG. 4 is used for entering inputs for newly generating the timeline information. Guide information is displayed in the menu page 51. According to this, fingerprint information of the patient P is input to the portable terminal device 26 by use of the fingerprint input device 53 in a step S10. A request for newly generating the timeline information is generated upon inputting the fingerprint information together with the fingerprint information. The portable terminal device 26 transmits the request for the new entry to the emergency server apparatus 22 in a step S11.

The emergency server apparatus 22, upon receiving the request for the new entry in a step S12, generates emergency timeline information TL0 in a step S13, and generates a case ID in a step S14. The emergency server apparatus 22 registers the emergency timeline information TL0 in the emergency database 42 by associating the fingerprint information and the case ID according to the request, in a step S15.

Then the portable terminal device 26 registers (adds) the medical care information. The menu page 51 is used to enter inputs for registering the medical care information. In the patient list, a case ID is designated to transmit a request to the emergency server apparatus 22 for registering the medical care information in a step S16. The emergency server apparatus 22 registers the medical care information (service item) with the emergency timeline information TL0 of the designated case ID according to the request in a step S17.

In case the ambulance crew 17 transports the patient P to the first hospital facility 13, the hospital terminal apparatus 27 and the hospital server apparatus 23 generate the first hospital timeline information TL1 in the first hospital facility 13 in the same manner for registration. In case the patient P is transferred to the second hospital facility 14, the hospital terminal apparatus 28 and the hospital server apparatus 24 generate the second hospital timeline information TL2 in the second hospital facility 14 in the same manner for registration.

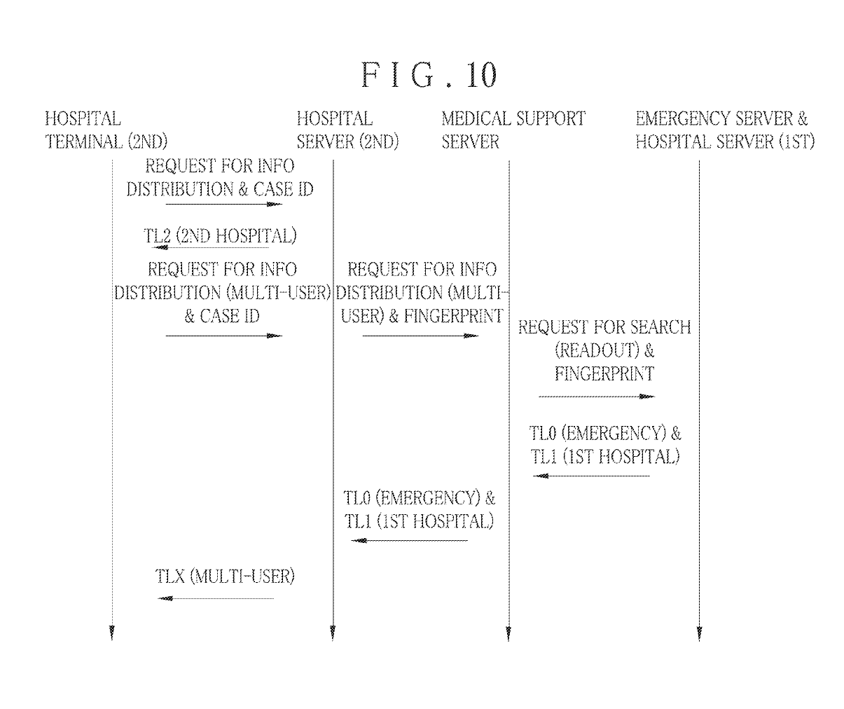

Assuming that the doctor D2 of the second hospital facility 14 wishes to view the second hospital timeline information TL2 of the patient P as illustrated in FIG. 10, he or she operates the hospital terminal apparatus 28 to transmit a normal request for information distribution to the hospital server apparatus 24 by entry of the case ID. The hospital server apparatus 24 upon receiving the request for the information distribution searches the second hospital timeline information TL2 of the entered case ID from the hospital database 44, and transmits the second hospital timeline information TL2 to the hospital terminal apparatus 28.

Assuming that the doctor D2 wishes to view timeline information retrospectively before the transfer of the patient P to the second hospital facility 14, the hospital terminal apparatus 28 transmits a request for the information distribution of the multi-user timeline information (combined timeline information) for the case ID to the hospital server apparatus 24.

The hospital server apparatus 24 in response to this request reads out fingerprint information from the hospital database 44 in correspondence with the designated case ID, and transmits a request for the information distribution to the medical support server apparatus 21 with attachment of the fingerprint information.

The medical support server apparatus 21 upon receiving the request for the information distribution transmits a request for search (readout) with the fingerprint information to medical service providers other than the second hospital facility 14 as a requester of the request, namely, to the emergency response organization 12 and the first hospital facility 13. The emergency server apparatus 22 and the hospital server apparatus 24 upon receiving the request for the search perform the search of the timeline information TL0 and TL1 with identity verification of the attached fingerprint information, and transmit a search result to the medical support server apparatus 21. The medical support server apparatus 21 distributes the emergency timeline information TL0 and second hospital timeline information TL2 to the hospital server apparatus 24 as requester.

The hospital server apparatus 24 generates the multi-user timeline information TLX by combining the timeline information TL0 and TL1 of the other medical service providers (users) from the medical support server apparatus 21 with the timeline information TL2 with identity verification of the fingerprint information in the hospital database 44. The multi-user timeline information TLX is transmitted to the hospital terminal apparatus 28 as a requester. Thus, the doctor D2 can view the timeline information retrospectively in relation to the patient P prior to the transfer to the second hospital facility 14.

In FIG. 10, the hospital terminal apparatus 28 at the second hospital facility 14 generates a request for the information distribution for searching and viewing timeline information of other medical service providers. However, it is possible to generate a request for the information distribution from the portable terminal device 26 or the hospital terminal apparatus 27 of the first hospital facility 13 or the paramedic F, in order to search and view timeline information of other medical service providers.

As described heretofore, the medical support system 10 of the invention can register the fingerprint information with the timeline information in a tagged form, and search and transmit timeline information with identity verification of the fingerprint information. The fingerprint information is biometric information for identifying the patient P unlike the case ID generated specifically by one of the medical service providers. It is possible with the fingerprint information relatively easily to acquire timeline information created by other medical service providers for the same patient, in comparison with utilization of personal information such as a name, age, sex, address and the like for identifying the patient.

Consequently, it is possible easily to view and share plural sets of timeline information created in the medical service providers even upon occurrence of changeover between those for performing medical care to the patient P, such as the ambulance crew 17, and the first and second hospital facilities 13 and 14.

Furthermore, visual perceptibility of plural sets of the timeline information can be set high by matching operation or combining operation of the plural sets of the timeline information along the timeline bar of a time sequence upon identity verification in the biometric information. The matching operation is typically effective in the case of a high number of the sets of the timeline information.

### Second Embodiment

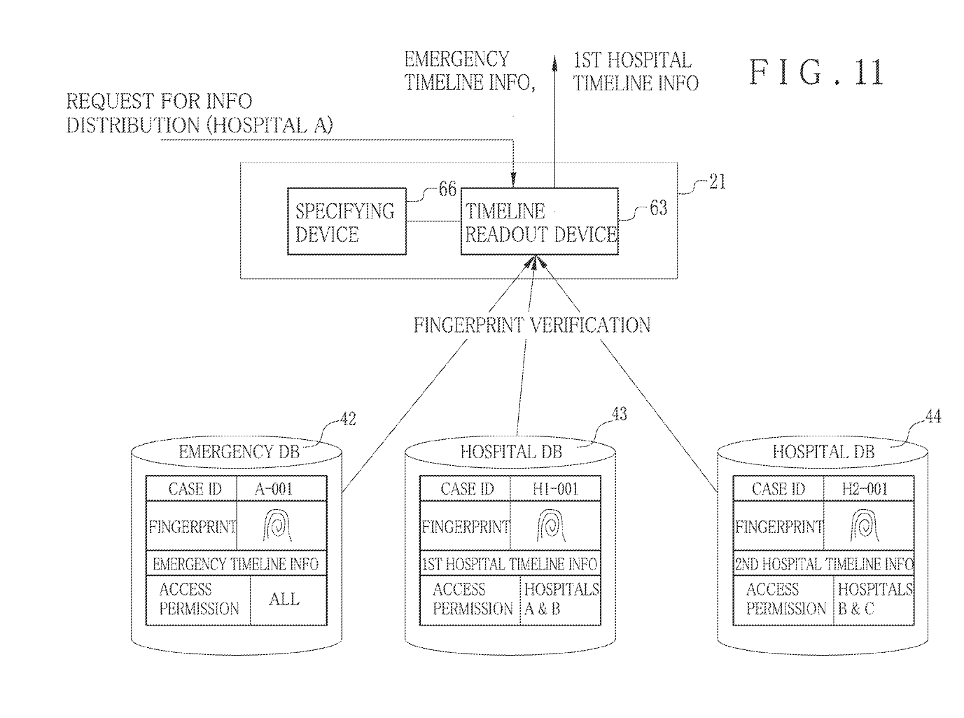

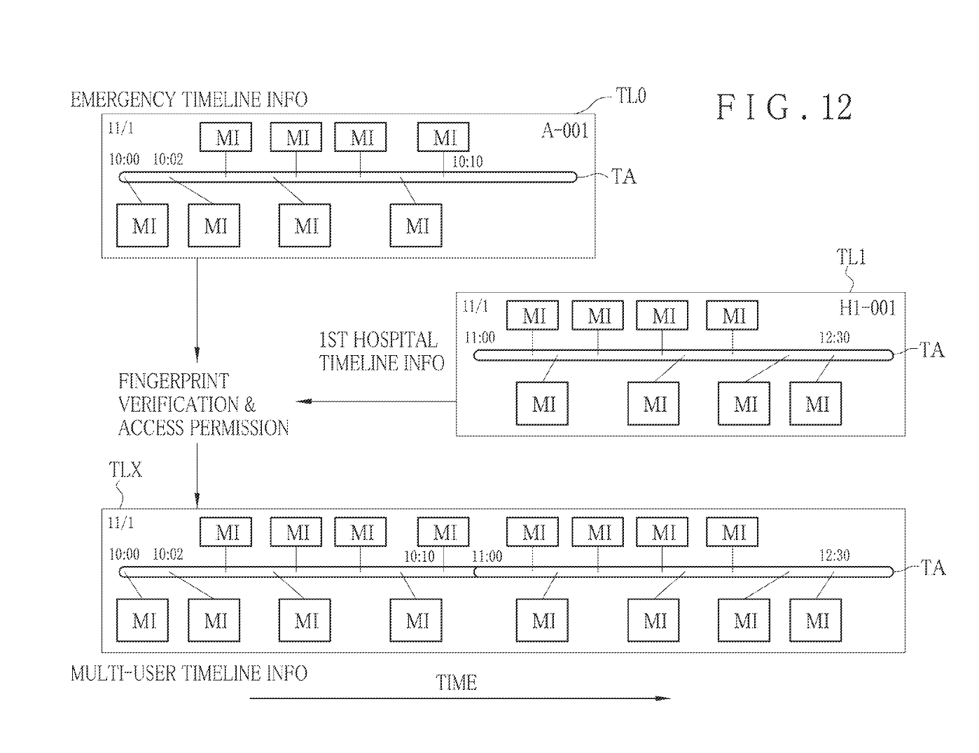

The medical support server apparatus 21 in the first embodiment performs the information distribution of all the timeline information in correspondence with the fingerprint information. In contrast, a second preferred embodiment in FIGS. 11 and 12 has a function of access restriction for each one of sets of the timeline information.

In FIG. 11, associated information (specific information or key information) for access restriction for each set of the timeline information is registered in a tagged form in the plural databases 42, 43 and 44 in the plural server apparatuses 22, 23 and 24. The associated information is combined with flag information of “access permission”. Examples of the associated information are service provider IDs, for example, hospitals A and B. For example, a terminal apparatus at the hospital A is permitted to perform access, but one at the hospital B is disabled to perform access. Assuming that the access is free without the restriction, “ALL” is designated for access permission, which is indicated at the emergency timeline information TL0 with a case ID of A-001.

Also, a specifying device 66 is provided in the medical support server apparatus 21 for operation by running a server program for medical support. The timeline readout device 63 searches and reads out timeline information. The specifying device 66 specifies the timeline information to which a requester or user of the request of the information distribution is permitted to perform access, according to the associated information combined with the timeline information being read out.

For example, a terminal apparatus of a hospital A receives a request for the information distribution of a requester of the request. Then the timeline readout device 63 in the medical support server apparatus 21 acquires timeline information from the plural databases 42, 43 and 44 of the medical service providers upon identity verification of the fingerprint information. One of the sets of the timeline information read out by the timeline readout device 63 is detected by the specifying device 66 for accessibility to the requester of the request.

Specifically, the specifying device 66 reads out hospital information (service provider ID) of a medical service provider of the requester of the request from the request for information distribution, for example, the hospital A. The specifying device 66 detects the timeline information with accessibility from the hospital A. The second hospital timeline information TL2 in the hospital database 44 at the second hospital facility 14 is inhibited from being accessed by the hospital A in the access restriction. Thus, the specifying device 66 judges that the emergency timeline information TL0 and the first hospital timeline information TL1 are timeline information to which the hospital A is permitted to perform access.

In FIG. 12, the timeline information with accessibility is transmitted to a server apparatus at the hospital A as a requester. The server apparatus combines plural sets of the timeline information to generate multi-user timeline information TLX, which is transmitted to the terminal apparatus of the requester. In short, the access permission is determined according to the associated information in addition to the identity verification of the fingerprint information. Only the timeline information with the access permission is distributed.

Examples of the associated information (specific information or key information) include a service provider ID of a medical service provider, and a professional category, such as a doctor, nurse and the like. Access restriction can be so determined that the doctor is permitted to view the timeline information, but that the nurse is disabled from viewing the timeline information. Furthermore, a data amount of the available timeline information can be set larger for a doctor with permitted access in relation to medical care of a patient, but can be set smaller for a nurse, technician, paramedic and the like with limited access in relation to the medical care.

A further example of the user information can be a terminal ID of a terminal apparatus used by a medical professional, such as a doctor, nurse or the like. The access restriction can be set up specifically by each professional. Examples of the user information can be the service provider ID, professional category and terminal ID for recognizing a user permitted to use timeline information. Also, two or more of the types of the user information can be used in combination, for example, the terminal ID and the professional category.

Furthermore, associated information (specific information or key information) for use in access restriction can be area information for possibility of transmitting the timeline information in place of the use information.

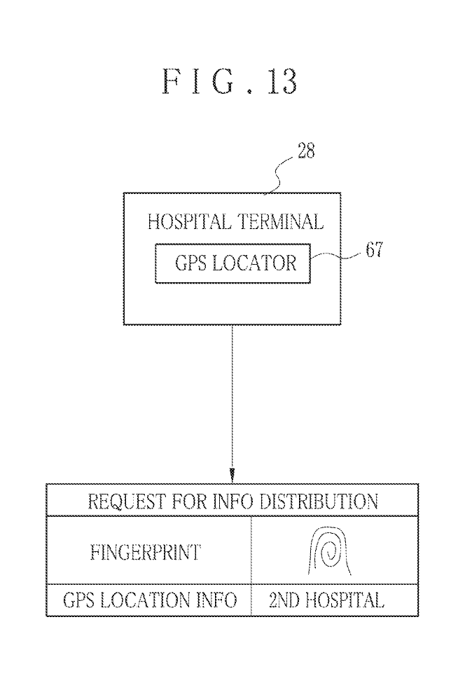

In FIG. 13, a GPS locator 67 is provided in each of the portable terminal device 26 and the hospital terminal apparatuses 27 and 28. GPS location information received by the GPS locator 67 in the plural terminal apparatuses 26, 27 and 28 is associated with a request for the information distribution output by the plural terminal apparatuses 26, 27 and 28 together with the fingerprint information of the patient P. Note that the hospital terminal apparatus 28 transmits the request for the information distribution in FIG. 13, in combination with the GPS location information of an on-site location in the second hospital facility 14.

The specifying device 66 specifies the timeline information to which a requester or user can perform access, according to the GPS location information combined with the request for the information distribution. Multi-user timeline information is generated from the timeline information with access permission after the specification in the specifying device 66.

### Third Embodiment

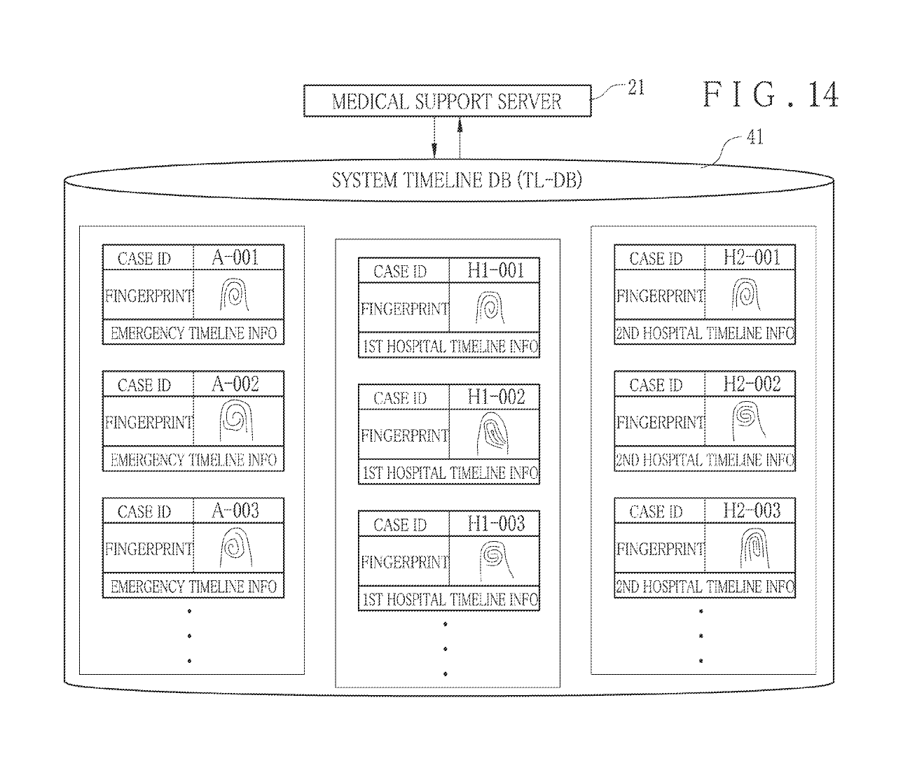

In FIG. 14 for a third preferred embodiment, a system timeline database 41 or system workflow database or DB is combined with the medical support server apparatus 21 for storing various sets of timeline information created by plural medical service providers in a comprehensive manner. The timeline information upon being registered in the plural server apparatuses 22, 23 and 24 is uploaded to the medical support server apparatus 21 readily after the registration. The medical support server apparatus 21 searches and reads the plural sets of the timeline information of the same patient P from the system timeline database 41 by checking the fingerprint information associated with a request for information distribution.

### Fourth Embodiment

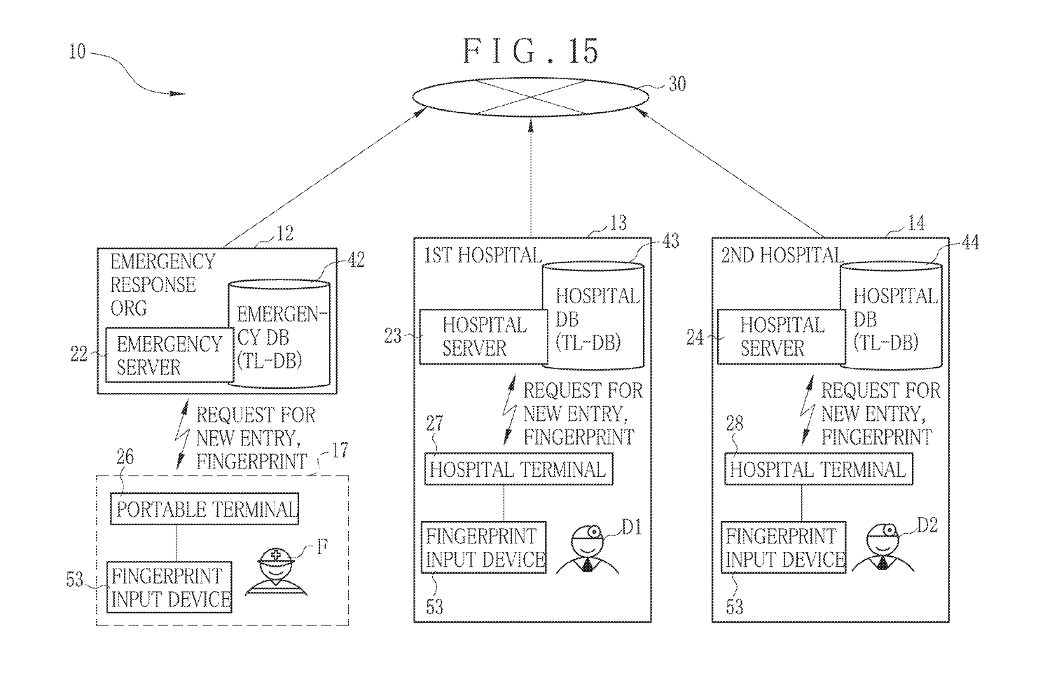

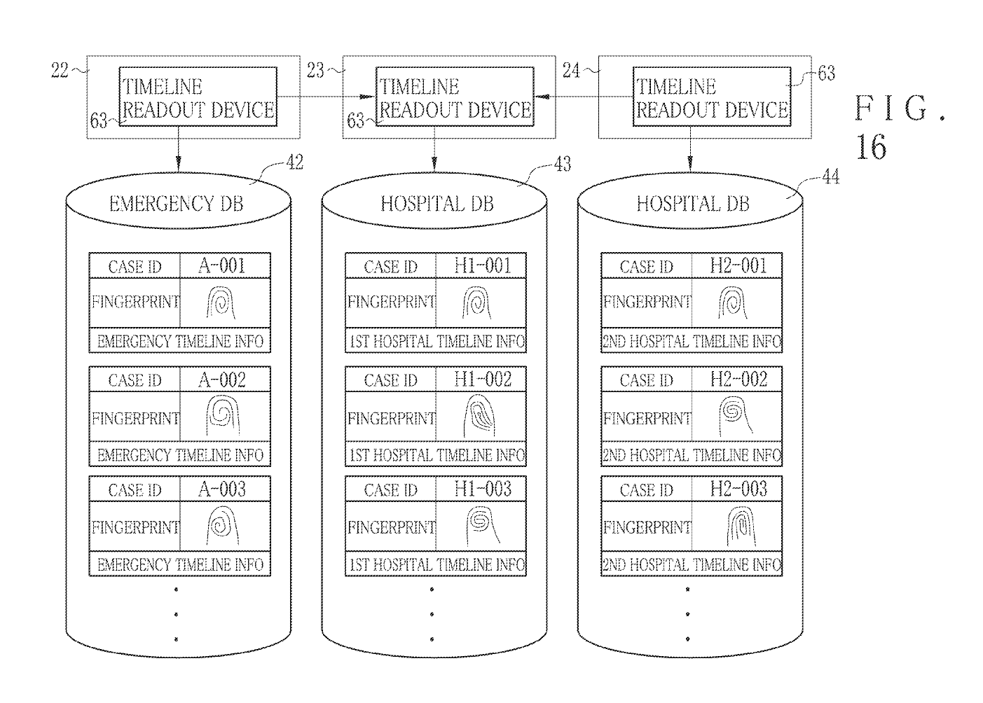

In FIGS. 15 and 16, a fourth preferred embodiment is illustrated. The plural server apparatuses 22, 23 and 24 are used as medical support server apparatuses without installing a medical support server apparatus discrete from the plural server apparatuses 22-24. In FIG. 16, the timeline readout device 63 is disposed in the plural server apparatuses 22, 23 and 24. Upon receiving a request for the information distribution of timeline information from a terminal apparatus, the timeline readout device 63 (searcher) in the plural server apparatuses 22, 23 and 24 transmits a request for search (readout) to other medical service providers. Fingerprint information of a patient of interest is combined with the request for the search.

In the same manner as the first embodiment, the plural server apparatuses 22, 23 and 24 receiving the request for the search perform the search of the timeline information with identity verification of the associated fingerprint information, and transmits the searched timeline information to the requester or server apparatus. Thus, the plural server apparatuses 22, 23 and 24 can acquire the timeline information of the plural medical service providers. In short, the timeline manager 54, the timeline entry device 55 and the timeline readout device 63 are established in each of the plural server apparatuses 22, 23 and 24.

In the above embodiments, the multi-user timeline information is generated from the plural sets of the timeline information. However, it is unnecessary to generate multi-user timeline information. The plural sets of the timeline information can be transmitted to a requester of the request as a terminal apparatus without generating the multi-user timeline information.

In the above embodiments, the requests for the new entry and for the information distribution are generated upon each time of the changeover between the medical service providers where the patient is transported or transferred. However, the invention is not limited. For example, one terminal apparatus can be allocated with a patient at the time of starting first medical care by an ambulance crew. Even upon occurrence of changeover between the medical service providers, the same terminal apparatus can be continuously used for the same patient.

To this end, the common terminal apparatus performs access to server apparatuses of different medical service providers to register timeline information of the medical care information. For example, it is necessary incessantly to monitor vital information of a patient assuming that he or she is seriously sick. Even in case there occurs changeover from one medical service provider to another, it is possible to monitor the vital information by continuously using the same common terminal apparatus, to register the vital information with the timeline information.

It is preferable to combine the location information with the request for the new entry to be transmitted from the same terminal apparatus, and to change the type of the timeline information to be registered according to the location information. For example, let the location information express a location outside the hospital facility. Emergency timeline information is registered in an emergency timeline information database. Also, let the location information express an on-site location in first or second hospital facility. First or second hospital timeline information is registered in respectively a first or second hospital timeline information database. Furthermore, the emergency timeline information can be generated by transmitting a request for the new entry in combination with the location information outside the hospital facility during transfer from the first hospital facility to the second hospital facility. Note that the location information for combination with the request for the new entry is preferably GPS location information in the same manner as FIG. 13.

In the above embodiments, the request for the new entry and the request for the information distribution are generated by the emergency terminal apparatus or hospital terminal apparatus in each of the medical service providers. However, the terminal apparatus is not limited, and can be a triage apparatus, vital sign measurement apparatus, diagnostic imaging apparatus and the like. Such an apparatus can have functions for generating and transmitting the request for the new entry and the request for the information distribution. In the embodiments, the biometric information is the fingerprint information. However, other examples of the biometric information of a patient can be used, such as a palm print, iris pattern of a pupil, veins of a palm, voice print, and the like. Also, two or more examples of the biometric information can be combined for use. This is effective in raising precision in identifying each of the patients.

In the above embodiments, the ambulance crew is constituted by the paramedics. However, emergency medical technicians (EMT) and the like can be included. In the above embodiments, a vehicle for the emergency medicine is the ambulance. However, a helicopter, aircraft and the like for medical use can be used instead of the ambulance. In the above embodiments, the medical service providers for diagnosis and treatment are the hospital facilities. However, a clinic, sanatorium and other facilities can perform medical care instead of the hospital facilities.

Furthermore, it is possible in the medical support system for use with timeline information of the invention to combine known structures of a workflow system for use with workflow information, time charts, timetables, electronic medical records (EMRs) and the like.

According to one embodiment mode of the invention, a non-transitory computer readable medium for storing a computer-executable program is provided, the computer-executable program enabling execution of computer instructions to perform operations for providing timeline information having medical care information of a patient arranged in a time sequence for use in medical care of the patient. The operations include receiving an entry request for newly entering the timeline information in association with biometric information for identifying the patient. The operations include newly generating the timeline information upon receiving the entry request. The operations include registering the timeline information in a storage medium in association with the biometric information. The operations include reading out the timeline information from the storage medium by search upon identity verification of the biometric information. The operations include performing information distribution of the timeline information being read out.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical support system for providing timeline information having medical care information of a patient arranged in a time sequence for use in medical care of said patient, comprising:
a timeline entry device for registering said timeline information in a storage medium in association with biometric information for identifying said patient;
a timeline readout device for reading out said timeline information from said storage medium by search upon identity verification of said biometric information;
an information distributor for information distribution of said timeline information being read out.

2. A medical support system as defined in claim 1, further comprising a timeline matching device for operating upon acquiring plural sets of said timeline information with identity verification of said biometric information, and generating multi-user timeline information by matching said plural sets of said timeline information in said time sequence.

3. A medical support system as defined in claim 2, wherein said timeline entry device registers associated information in association with said timeline information, and said associated information is used for determining permission of access to said timeline information.

4. A medical support system as defined in claim 3, wherein said associated information includes at least one of user information of a user permitted to perform access to said timeline information, and area information of an area in which information distribution of said timeline information is possible.

5. A medical support system as defined in claim 4, further comprising a specifying device for operating upon receiving a request from a requester among plural users, and selectively specifying said timeline information to which said requester is permitted to perform access according to said associated information, to transmit said timeline information to said requester.

6. A medical support system as defined in claim 5, wherein location information of said requester is acquired by a GPS locator, and transmitted from said requester together with said request;
said specifying device specifies said timeline information of accessibility by use of said location information and said area information.

7. A medical support system as defined in claim 2, wherein said timeline entry device is provided with said timeline information by each of plural medical service providers for said medical care of said patient;
said information distributor performs information sharing of said timeline information between said medical service providers.

8. A medical support system as defined in claim 7, wherein said medical service providers include an ambulance crew and at least one hospital facility.

9. A medical support system as defined in claim 2, comprising plural server apparatuses each of which includes said timeline entry device, said timeline readout device and said timeline matching device.

10. A medical support system as defined in claim 9, wherein said plural server apparatuses include:
a first server apparatus for outputting a request for reading out said timeline information;
a second server apparatus for reading out said timeline information by referring to said biometric information in response to outputting said request for readout, and for transmitting said timeline information to said first server apparatus by use of said information distributor.

11. A medical support system as defined in claim 1, wherein said biometric information is fingerprint information.

12. A medical support system as defined in claim 1, wherein said timeline entry device receives an entry request for newly entering said timeline information in association with said biometric information, and newly generates said timeline information upon receiving said entry request.

13. A medical support system as defined in claim 2, further comprising:
a local server apparatus for outputting a request for reading out said timeline information;
a medical support server apparatus, including said timeline entry device, said timeline readout device and said timeline matching device, for reading out said timeline information by referring to said biometric information in response to outputting said request for readout, and for transmitting said timeline information to said first server apparatus by use of said information distributor.

14. A medical support method for providing timeline information having medical care information of a patient arranged in a time sequence for use in medical care of said patient, comprising steps of:
receiving an entry request for newly entering said timeline information in association with biometric information for identifying said patient;
newly generating said timeline information upon receiving said entry request;
registering said timeline information in a storage medium in association with said biometric information;
reading out said timeline information from said storage medium by search upon identity verification of said biometric information;
performing information distribution of said timeline information being read out.

15. A medical support apparatus for providing timeline information having medical care information of a patient arranged in a time sequence for use in medical care of said patient, comprising:
a request processing unit for receiving an entry request for newly entering said timeline information in association with biometric information for identifying said patient;
a timeline generator for newly generating said timeline information upon receiving said entry request;
a timeline entry device for registering said timeline information in a storage medium in association with said biometric information;
a timeline readout device for reading out said timeline information from said storage medium by search upon identity verification of said biometric information;
an information distributor for information distribution of said timeline information being read out.
